(19) United States
(12) Patent Application Publication
(10) Pub. No.: US 2005/0008468 A1
(43) Pub. Date: Jan. 13, 2005

(54) Self-propelled working machine

(76) Inventors: Makoto Sugaya, Chiba (JP); Tsukasa Toyooka, Ibaraki (JP); Masashi Nakanishi, Ibaraki (JP); Osamu Gokita, Ibaraki (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/496,972

(22) PCT Filed: Mar. 18, 2003
(86) PCT No.: PCT/JP03/03284

(30) Foreign Application Priority Data
Mar. 22, 2002 (JP) 200281800

(51) Int. Cl. B66F 9/00

(52) U.S. Cl. 414/680

(57) ABSTRACT

A vehicular body oscillating mechanism (31) is provided between a frame (3) of an automotive vehicular body (2) and a stabilizer (18) thereby to sway the vehicular body (2) arcuately in a rightward and/or leftward direction about a pivot point (A) between right and left rear wheels (6, 7) when the stabilizer (18) is set on the ground for a load handling operation. This means that, after the stabilizer (18) is set on the ground for a load handling operation, the vehicular body (2) can be swayed arcuately laterally in a rightward and/or leftward direction together with a load lifting mechanism (12). Therefore, at the time of a load handling operation with the stabilizer (18) set on the ground for stabilization of the vehicular body (2), it is possible to turn and move the load lifting mechanism (12) into a rightward or leftward direction to adjust the position or direction of lifted freight goods in case it is deviated from a specified unloading spot in a lateral direction. Namely, in a load handling operation, the load lifting mechanism (12) can be adjusted in a lateral direction to dump lifted freight goods exactly on a specified unloading spot.

### TECHNICAL FIELD

This invention relates to an automotive working machine, for example, an automotive working machine which is provided with an automotive vehicular body like a lift truck.

### BACKGROUND ART

Generally, as an automotive working machine which is used for lifting freight or cargo from the ground level to a height, there have been known in the art the so-called lift trucks having an automotive vehicular body with right and left front wheels and right and left rear wheels provided at the opposite lateral sides of a longitudinally extending frame, and a load lifting working mechanism provided on the frame for lifting a load up and down (e.g., as disclosed in Japanese Patent Laid-Open No. S50-19148).

In the case of the lift truck according to the prior art just mentioned, for example, freight goods which are loaded on a lift tool like a fork at the fore end of the load lifting working mechanism are carried by the truck as far as a point in the vicinity of a predetermined freight dumping spot. After stopping in the vicinity of the predetermined freight dumping spot, the loaded freight goods are lifted and then dropped on the predetermined dumping spot by the load lifting mechanism.

Normally, the load lifting mechanism which is provided on the above-mentioned lift truck is capable of moving vertically up and down relative to the automotive vehicle body but incapable of making turns rightward or leftward direction (horizontally in a lateral direction) because of its own construction.

Therefore, in the case of the lift track according to the prior art, where freight loading and unloading stations or spots happen to be located on the different lateral sides relative to the direction of the truck body, the freight goods may be lifted by the load lifting mechanism in a direction which is deviated from a predetermined unloading station in a lateral direction. In such a case, for bringing the freight goods to a correct unloading position, the lift truck has to be moved again with the freight goods in the lifted state.

On the other hand, as another example of prior art lift trucks, there has been known a lift truck having a stabilizer provided fixedly thereon to stabilize the vehicular body during load handling operations (e.g., as disclosed in the specification of French Patent No. 2725191-A1).

In the case of the stabilizer-equipped lift truck just mentioned, the stabilizer is set on the ground of a working site for stabilization of the vehicle body, ensuring safe transportation of heavy and large freight goods by the use of a load lifting mechanism.

In this connection, in the case of the stabilizer-equipped lift truck, for the purpose of stabilizing the vehicle body, it is necessary to set the stabilizer on the ground at the time of handling large and heavy freight goods. However, the conventional lift truck with a stabilizer has a problem in that it cannot be put in travel once a stabilizer is set on the ground for a stabilized freight handling operation.

Namely, there has been a problem with conventional lift trucks with a stabilizer in that, during a load lifting operation with a stabilizer deployed to set foot on the ground for stabilization of the vehicular body, it has thus far been often found difficult to adjust the position or direction of freight goods uplifted by a load lifting mechanism correctly toward a predetermined unloading station particularly in a case where loading and unloading stations are located on different sides of the vehicular body.

### DISCLOSURE OF THE INVENTION

In view of the above-discussed problems with the prior art, it is an object of the present invention to provide an automotive working machine which can adjust the direction of a load handling mechanism in a rightward and/or leftward direction during a load handling operation, even after a stabilizer has been set on the ground for stabilization of the vehicle body.

According to the present invention, in order to achieve the above-stated objective, there is provided an automotive working machine having: an automotive vehicular body including a longitudinally extending frame, right and left front wheels provided in a front portion of the longitudinal frame, and right and left rear wheels provided in a rear portion of the longitudinal frame through a differential device; a load lifting mechanism provided on said frame of the vehicular body; a stabilizer provided at a front end of the vehicular body and adapted to set foot on the ground for stabilization of the vehicular body at the time of a load handling operation by the load lifting mechanism.

The automotive working machine according to the present invention is characterized in that: a vehicular body oscillating mechanism is provided between the frame of the vehicular body and the stabilizer and actuated to sway the vehicular body arcuately in a rightward and/or leftward direction together with the load lifting mechanism, about a pivot point which is located between the right and left rear wheels, after the stabilizer is set on the ground for stabilization of the vehicular body during a load handling operation.

With the arrangements just described, the vehicular body oscillating mechanism can be operated in a rightward and/or leftward direction after the stabilizer has been set on the ground for stabilization of the vehicular body. At this time, the right and left rear wheels are rotated in the opposite directions by the differential device, and as a result a front portion of the vehicular body is swayed arcuately in a rightward and/or leftward direction along with the load lifting mechanism, about a pivot point between the right and left rear wheels. Accordingly, even after the stabilizer has been set on the ground for stabilization of the vehicle body, it is possible to sway the vehicular body in a rightward and/or leftward direction together with the load lifting mechanism for the purpose of adjusting freight goods lifted by the load lifting mechanism to correct unloading position. Therefore, even if the position or direction of lifted freight goods on the load lifting mechanism is deviated from the position of a specified unloading spot in a lateral direction, the position or direction of the load lifting mechanism can be easily adjusted to dump the lifted freight goods exactly on the specified unloading spot.

According to a preferred form of the present invention, the vehicular body oscillating mechanism is comprised by a bracket on the side of the vehicle body attached to the frame of the vehicular body, a bracket on the side of the stabilizer having the stabilizer attached thereto, a connecting member arranged to connect said bracket on the side of the vehicle body and said bracket on the side of the stabilizer pivotally with each other, and a hydraulic cylinder having one end thereof connected to the bracket on the side of the vehicle body and having the other end connected either to the bracket on the side of the stabilizer or to the connectiong member, the vehicular body oscillating mechanism being arranged to put the vehicular body in an oscillatory movement by telescopic expanding and contracting actions of the hydraulic cylinder.

With the arrangements just described, if the hydraulic cylinder of the vehicle body oscillating mechanism is contacted and expanded when the stabilizer is set on the ground, the bracket on the side of the vehicle body is swayed in a leftward and/or rightward direction relative to the bracket on the side of the stabilizer. This oscillatory movement of the bracket on the side of the vehicle body is transmitted to the frame of the vehicular body, causing the vehicular body to sway to the right and left together with the load lifting mechanism arcuately about a pivot point between the right and left rear wheels.

Further, according to a preferred form of the present invention, the above-mentioned connecting member is constituted by arcuate guide slots provided on one of the bracket on the side of the vehicular body and the bracket on the side of the stabilizer and extended arcuately about the pivot point, and a plural number of pins fixedly planted on the other one of the bracket on the side of the vehicular body and the bracket on the side of the stabilizer for engagement with the guide slots in spaced positions in the longitudinal direction of the guide slots.

With the arrangements just described, when the vehicular body is swayed in a rightward and/or leftward direction by the hydraulic cylinder of the vehicular body oscillating mechanism, the guide slots which are provided on one of the bracket on the side of the vehicular body and the bracket on the side of the stabilizer are brought into abutting engagement with pins which are provided on the other bracket. As a consequence, the vehicular body is swayed in a rightward and/or leftward direction arcuately about the pivot point between the right and left rear wheels under guidance of the arcuate slots.

Further, according to another preferred form of the present invention, tubular bushes are rotatably fitted on the pins for abutting engagement with inner surfaces of the guide slots. With the arrangements just described, as the vehicular body is swayed in a rightward and/or leftward direction by the hydraulic cylinder of the oscillating mechanism, the respective bushes are abutted against the guide slots and rotated relative to the pins in the fashion of rollers. As a result, the friction between the bushes and the guide slots is suppressed to ensure smooth oscillatory movement of the vehicular body.

Further, according to the present invention, the connecting member is constituted by arcuate guide slots which are provided on one of the bracket on the side of the vehicular body and the bracket on the side of the stabilizer and extended arcuately about the pivot point, a plural number of pins which are fixedly planted on the other one of the bracket on the side of the vehicular body and the bracket on the side of the stabilizer for engagement with the guide slots in spaced positions in the longitudinal direction of the guide slots, and tubular bushes rotatably fitted on said pins; the bracket on the side of the vehicular body and the bracket on the side of the stabilizer are vertically spaced apart by a gap space; and the bushes and the guide slots are horizontally spaced apart by a gap space; the bracket on the side of vehicular body and the bracket on the side of the stabilizer being brought into abutting engagement with each other and at the same time inner surfaces of the guide slots and the bushes being brought into abutting engagement with each other when the bracket on the side of the stabilizer and the bracket on the side of the vehicular body are inclined relative to each other within ranges of the gap spaces.

With the arrangements just described, when the stabilizer is set down on the ground for a load handling operation, the bracket on the side of the stabilizer and the bracket on the side of the vehicular body can be inclined relative to each other by a load imposed by the vehicular body. On such an occasion, the bracket on the side of the vehicular body and the bracket on the side of the stabilizer are brought into abutting engagement with each other, and at the same time inner surfaces of the guide slots and the bushes are brought into abutting engagement with each other. Therefore, loads which are imposed by the vehicular body can be sustained by the abutting portions of the bracket on the side of the vehicular body and the bracket on the side of the stabilizer as well as by the abutting portions of inner surfaces of the guide slots and bushes, thereby stabilizing the vehicular body oscillating operation.

Furthermore, according to the present invention, inner surfaces of the guide slots are formed as inclined surfaces at the same angle as the angle of inclination occurring to the bracket on the side of the stabilizer relative to the bracket on the side of the vehicle body.

With the arrangements just described, when the bracket on the side of the stabilizer is inclined relative to the bracket on the side of the vehicular body by a load imposed by the vehicular body, outer peripheral surfaces of the bushes are abutted tightly against the inclined inner surfaces of the guide slots. In this case, the contacting surface areas between the guide slots and bushes are increased, and a load from the vehicular body can be sustained securely by abutting portions of inner surfaces of the guide slots and bushes.

Further, according to the present invention, the connecting member is constituted by arcuate guide members provided on one of the bracket on the side of the vehicular body and the bracket on the side of the stabilizer and extended arcuately about the pivot point, and slide members provided on the other one of the bracket on the side of the vehicular body and the bracket on the side of the stabilizer and held in sliding engagement with the guide members.

With the arrangements just described, when the vehicular body is swayed in a rightward and/or leftward direction by the hydraulic cylinder of the vehicle body oscillating mechanism, the guide members which are provided on one of the bracket on the side of the vehicular body and the bracket on the side of the stabilizer are held in sliding contact with slide members which are provided on the other one of the two brackets, thereby guiding the direction of oscillatory movement of the vehicular body arcuately along the shape of the guide members.

### BRIEF DESCRIPTION OF THE DRAWINGS

In the accompanying drawings:

FIG. 1 is a front view of a lift truck according to a first embodiment of the present invention;

FIG. 2 is a plan view of the lift truck of FIG. 1 taken from above;

FIG. 3 is a partly cutaway front view of a stabilizer and a vehicular body oscillating mechanism in FIG. 1;

FIG. 4 is a fragmentary sectional view showing on an enlarged scale a bracket on the side of the vehicle body, a bracket on the side of the stabilizer, guide slots, pins and bushes in FIG. 3;

FIG. 5 is a perspective view of the stabilizer and the vehicular body oscillating mechanism in the first embodiment of the invention;

FIG. 6 is an exploded perspective view of the bracket on the side of the vehicular body and the bracket on the side of the stabilizer shown in FIG. 5;

FIG. 7 is a plan view of hydraulic cylinder, slot and pins taken from above;

FIG. 8 is a plan view similar to FIG. 7 but showing the hydraulic cylinder in a stretched state;

FIG. 9 is a plan view schematically showing the way the vehicular body is swayed upon expansion of the hydraulic cylinder;

FIG. 10 is a plan view schematically showing the way the vehicular body is swayed upon contraction of the hydraulic cylinder;

FIG. 11 is a partly cutaway front view similar to FIG. 3 but showing stabilizer and vehicular body oscillating mechanism adopted in a second embodiment of the present invention;

FIG. 12 is an exploded perspective view of a bracket on the side of the vehicular body and a bracket on the side of the stabilizer in the second embodiment of the invention;

FIG. 13 is a plan view of a hydraulic cylinder, slot and pins, taken from above;

FIG. 14 is a fragmentary sectional view showing the bracket on the side of the vehicle body, bracket on the side of the stabilizer, slots and bushes in FIG. 11 on an enlarged scale;

FIG. 15 is an enlarged sectional view similar to FIG. 14 but showing the bracket on the side of the stabilizer in a tilted state;

FIG. 16 is a front view similar to FIG. 3 but showing a stabilizer and a vehicular body oscillating mechanism adopted in a third embodiment of the invention;

FIG. 17 is a sectional view of hydraulic cylinder, guide plate and slide plate, taken in the direction of arrows XVII-XVII in FIG. 16;

FIG. 18 is an enlarged sectional view similar to FIG. 14 but showing a first modification employed in place of the slot in the second embodiment;

FIG. 19 is an enlarged sectional view similar to FIG. 18 but showing the first modification with a bracket on the side of the stabilizer in a tilted state;

FIG. 20 is a front view similar to FIG. 3 but showing a second modification adopted in place of the stabilizer in the first embodiment;

FIG. 21 is a perspective view similar to FIG. 5 but showing a stabilizer and a vehicular body oscillating mechanism in the second modification; and

FIG. 22 is a plan view similar to FIG. 7 but showing a third modification adopted in place of the vehicular body oscillating mechanism in the first embodiment.

### BEST MODE FOR CARRYING OUT THE INVENTION

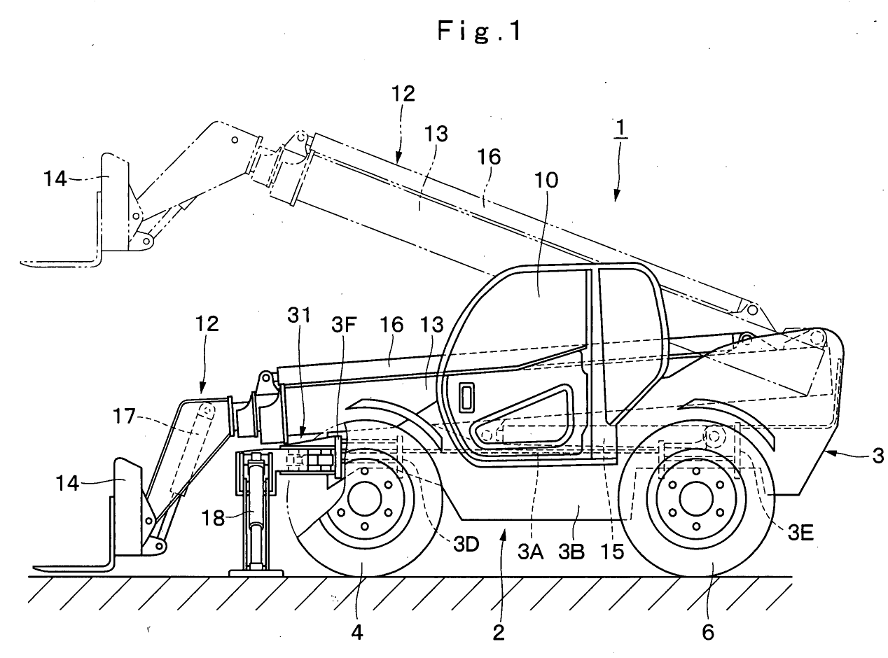

Hereafter, with reference to FIGS. 1 through 22 of the accompanying drawings, the automotive working machine according to the present invention is described more particularly by way of its preferred embodiments which are applied to a lift truck by way of example.

Referring first to FIGS. 1 thorough 10, there is shown a first embodiment of the present invention. In these figures, indicated at 1 is a lift truck which is arranged to serve for freight handling jobs, for example, for lifting freight goods up to a height from a ground surface. The lift truck 1 is largely constituted by a wheel type automotive vehicular body 2, a load lifting mechanism 12, a stabilizer 18, and a vehicular body oscillating mechanism 31, which will be described hereinlater.

Indicated at 3 is a base frame of the vehicular body 2. The frame 3 is fabricated from thick steel plates, including a longitudinally extending bottom plate 3A, and a couple of upright and longitudinally extending side plates 3B and 3C which are securely fixed to the right and left sides of the bottom plates 3A to form a strong support structure. The frame 3 is provided with front and rear wheel support portions 3D and 3E in its fore and rear end portions to support thereon front wheels 4 and 5 which will be described hereinafter and rear wheels 6 and 7, respectively. Further, a laterally extending flange plate 3F is securely fixed at the fore end of the frame 3 between the right and left side plates 3C and 3B. A bracket 32 on the side of the vehicular body is attached to the flange plate 3F in the manner as described hereinafter.

Denoted at 4 and 5 are left and right front wheels which are mounted on front portions of the frame 3. More specifically, these left and right front wheels 4 and 5 are mounted on outer distal end portions of left and right front wheel axles 4A and 5A which are supported on the front wheel support portion 3D of the frame 3. Further, the left and right front wheels 4 and 5 are steered by a steering device (not shown) which is provided in a cab 10 which will be described hereinafter to let the vehicular body 2 run in a straightforward direction or turn in a rightward or leftward direction.

Indicated at 6 and 7 are the left and right rear wheels which are provided on a rear portion of the frame 3. These left and right rear wheels 6 and 7 are respectively mounted on outer distal end portions of rear wheel axles 6A and 7A which are rotatably supported on the rear wheel support portion 3E of the frame 3 through a differential device 8, which will be described hereinafter.

Designated at 8 is a differential device which is provided between the left and right rear wheels 6 and 7. This differential device 8 is located in an intermediate position between the left and right rear wheels 6 and 7. In this instance, the differential device 8 interconnects the rear wheel axles 6A and 7A, and is connected through a drive shaft 9 or the like to a hydraulic motor (not shown) which is provided on the vehicle as an automotive drive motor. As the hydraulic motor is turned on, rotation of the hydraulic motor is transmitted to the wheel axles 6A and 7A through the drive shaft 9 and the differential device 8, rotating the left and right wheels 6 and 7 and putting the vehicular body 2 in travel.

Indicated at 10 is a cab which is located on a longitudinally intermediate portion of the frame 3 between the left front wheel 4 and the left rear wheel 6. The cab 10 internally defines an operating room for a machine operator. Provided within the cab 10 are an operator's seat to be taken by an operator, a steering device for steering the left and right front wheels 4 and 5, and a number of control levers for operating a load lifting mechanism 12 although they are all omitted in the drawings.

Indicated at 11 is an engine cover which is provided on a longitudinally intermediate portion of the frame 3 between the right front wheel 5 and the right rear wheel 7. This engine cover 11 is arranged to cover engine, hydraulic pump, heat exchanger and other equipments (all not shown) which are provided on the frame 3.

Denoted at 12 is a load lifting mechanism which is located on the vehicular body 2 and which is provided with a load lifting member for the purpose of handling heavy freight goods or cargos. More specifically, in the case of the particular embodiment shown, the load lifting mechanism 12 is provided with a boom 13 which is connected to a top end portion at the rear end of the frame 3 through a pin joint, and a fork 14 which is pivotally supported at the fore distal end of the boom 13.

In this instance, the boom 13 is of a telescopic type which is constituted by three boom sections, i.e., a first boom section of a tubular shape which is located in the outermost position, a second boom section of a tubular shape which is extensibly accommodated in the first boom section, and a third boom section which is extensibly accommodated in the second boom section.

Provided between the frame 3 and the boom 13 is a boom lifting cylinder 15 for raising and lowering the boom 13 up and down. More particularly, the boom 13 is moved up and down by the boom lifting cylinder 15 as indicated by solid line and two-dot chain line in FIG. 1. A boom extending cylinder 16 is attached to the outer side of the boom 13 thereby to stretch the second boom section out of the first boom section. Further, a fork cylinder 17 is connected between a fore end portion of the boom 13 and a fork 14 for turning the latter up and down.

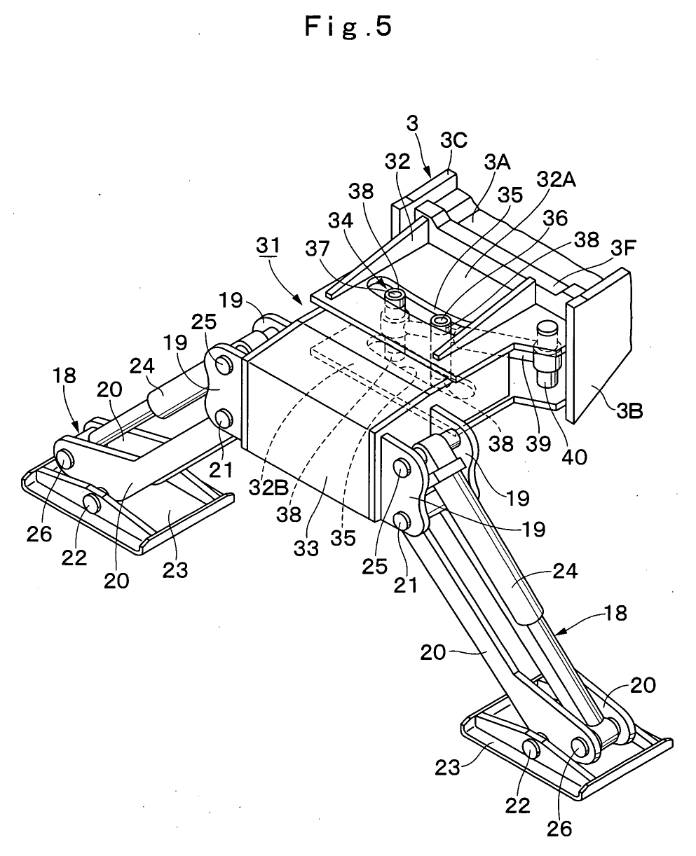

Indicated at 18 are left and right stabilizers which are supported on a front side portion of the vehicular body 2 (on the front side of the front wheels 4 and 5) through a bracket 33 on the side of the stabilizer in the manner as described hereinafter. During a freight handling operation by the load lifting mechanism 12, each stabilizer 18 is set on the ground for maintaining the vehicular body 2 in a stabilized state. As shown in FIG. 5 and other figures, each stabilizer 18 is largely constituted by support plates 19, arms 20, a footing plate 23 and a hydraulic cylinder 24.

Designated at 19 are the support plates which support base end portions of the arms 20 and the hydraulic cylinder 24. These support plates 19 are securely fixed to a bracket 33 on the side of the stabilizer, which will be described hereinafter. The arms 20 have respective base end portions pivotally supported on the support plates 19 through a pin 21. A footing plate 23 is pivotally connected to fore end portions of the arms 20 through a pin 22.

Indicated at 24 is the hydraulic cylinder for turning the arms 20 up and down. The bottom end of the hydraulic cylinder 24 is pivotally supported on the support plates 19 through a pin 25 at a higher position than the base end portions of the arms 20. The rod end of the hydraulic cylinder 24 is pivotally connected to fore distal end portions of the arms 20 through a pin 26. Thus, the support plates 19, arms 20 and hydraulic cylinder 24 are arranged to form a link mechanism.

When the automotive vehicular body 2 is put in travel, the hydraulic cylinders 24 of the stabilizer 18 are contracted to turn the arms 20 upwards, lifting the footing plates 23 off the ground surface. On the other hand, at the time of handling freight goods by the use of the load lifting mechanism 12, the hydraulic cylinders 24 of the stabilizer 18 are extended thereby turning the arms 20 downwards to let the footing plates 23 set foot on the ground for maintaining the vehicular body 2 in a stabilized state. In this manner, during a freight handling operation by the load lifting mechanism 12, the stabilizer 18 are turned downwards to grip the ground surface for stabilization of the vehicular body 2.

Indicated at 31 is a vehicular body oscillating mechanism which is provided between the frame 3 and the stabilizer 18. This vehicular body oscillating mechanism 31 is pivotally supported on the frame 3 between the front wheels 4 and 5. In this instance, the vehicular body oscillating mechanism 31 is constituted by a bracket 32 on the side of the vehicle body, a bracket 33 on the side of the stabilizer, a connecting member 34, and a hydraulic cylinder 39. When at work with the footing plates 23 of the stabilizer 18 set on the ground, the vehicular body 2 on the side of the front wheels 4 and 5 is put in sway movements by the vehicular body oscillating mechanism 31, about a pivot point A on the differential device 8 between the right and left rear wheels 7 and 6 along with the load lifting mechanism 12.

Indicated at 32 is a bracket on the side of the vehicle body, that is to say, a bracket which is provided at the fore end of the vehicular body 2. This bracket 32 on the side of the vehicular body is constituted by upper and lower plates 32A and 32B which are securely fixed to the flange plate 3F of the frame 3 by welding or by the use of bolts or other clamping means. These upper and lower plates 32A and 32B are so disposed as to confront each other through a spacing of a predetermined width, and are extended substantially in a horizontal direction.

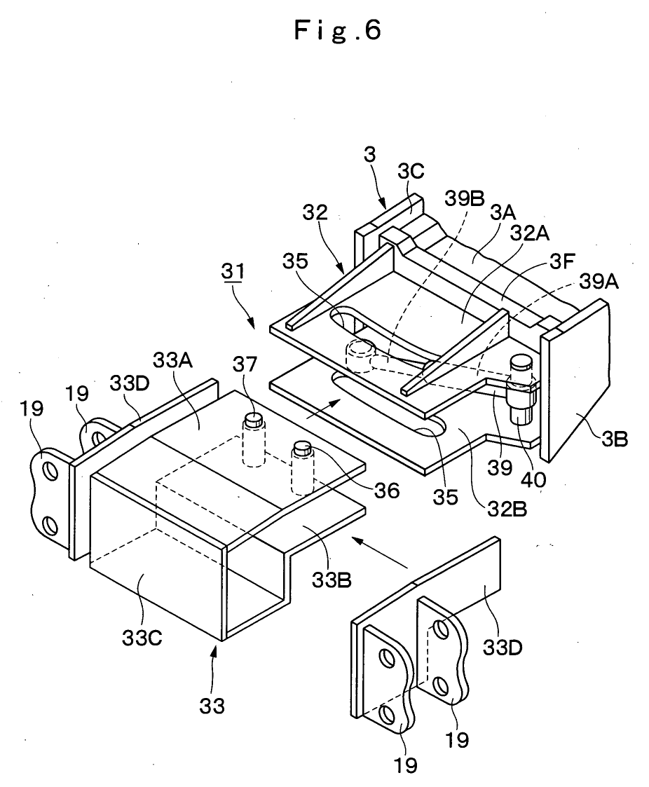

Denoted at 33 is a bracket on the side of the stabilizer, that is to say, a bracket which supports the stabilizer 18. As shown in FIG. 6, this bracket 33 on the side of the stabilizer is formed into a box structure by the use of upper plate 33A, lower plate 33B, front plate 33C and side plates 33D. In this instance, the support plates 19 for the right and left stabilizers 18 are securely fixed to the right and left side plates 33D by welding or by the use of other suitable fixation mean respectively.

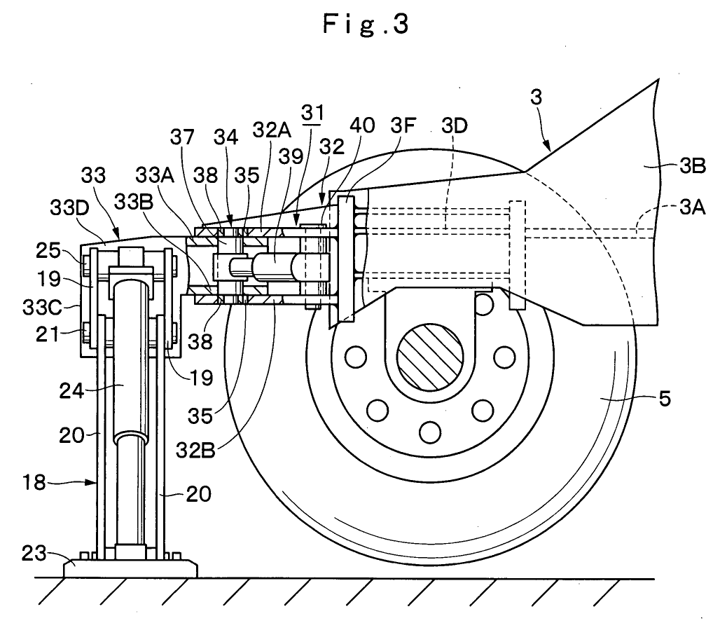

As shown in FIGS. 3 to 5, rear end portions of the upper and lower plates 33A and 33B of the bracket 33 on the side of the stabilizer are placed in the spacing between the upper and lower plates 32A and 32B of the bracket 32 on the side of the vehicle body, and are held in abutting engagement with the lower side of the upper plate 32A and the top side of the lower plate 32B of the bracket 32, respectively.

Indicated at 34 is a connecting member which is provided between the bracket 32 on the side of the vehicular body and the bracket 33 on the side of the stabilizer. This connecting member 34 serves to pivotally connect the bracket 32 on the side of the vehicular body with the bracket 33 on the side of the stabilizer. The connecting member 34 is constituted by slots 35, pins 36 and 37 and bush 38, which will be described hereinafter.

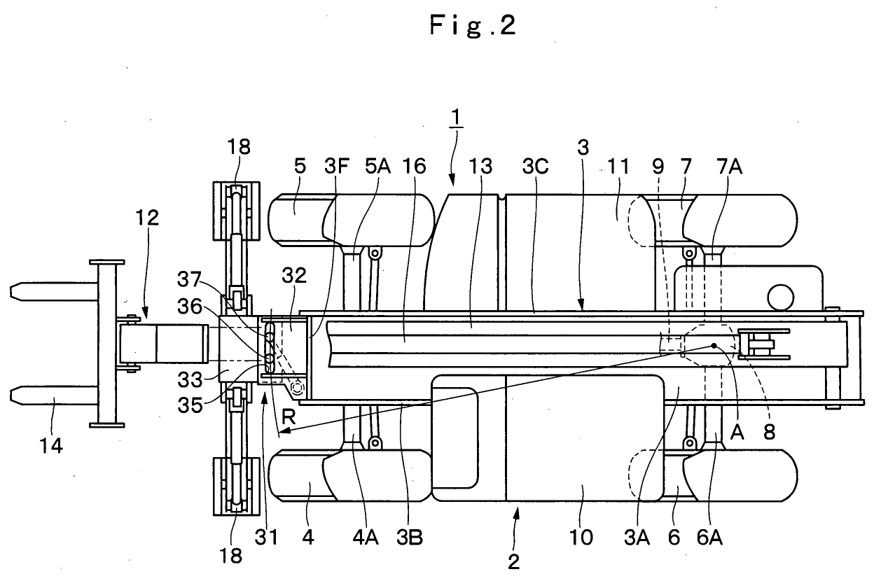

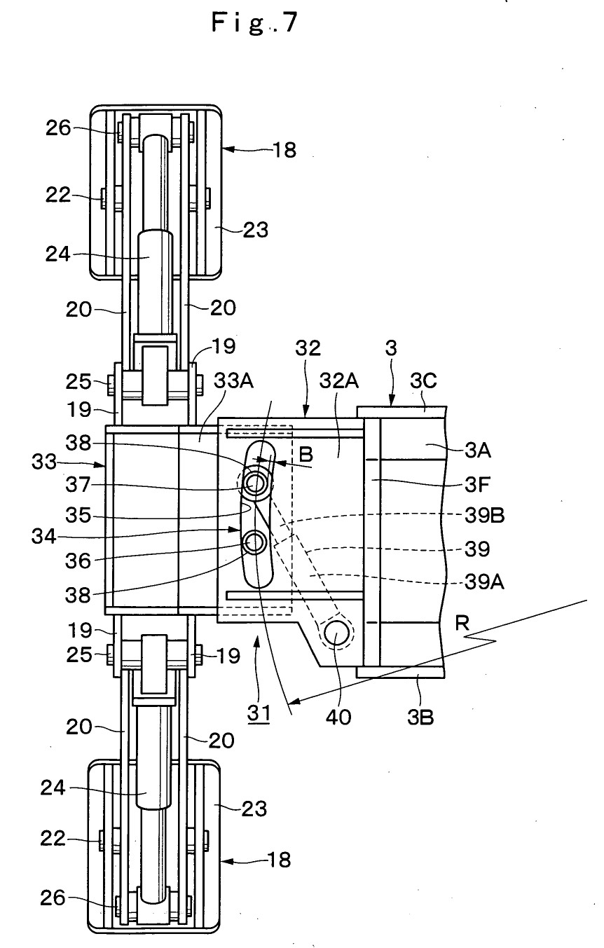

Denoted at 35 are guide slots which are formed in the upper and lower plates 32A and 32B of the bracket 32 on the side of the vehicle body. In this instance, as shown particularly in FIGS. 2 and 7, the slots 35 are aligned with each other in the vertical direction, and are formed in the shape of an arc of radius R having its center at a pivot point A between the left and right rear wheels 6 and 7.

Indicated at 36 and 37 are left and right pins which are provided on the bracket 33 on the side of the stabilizer in spaced positions in the longitudinal direction of the slots 35. These pins 36 and 37 are extended in the vertical direction in a fixed state between the upper and lower plates 33A and 33B of the bracket 33 on the side of the stabilizer. The opposite axial ends of the pins 36 and 37 are received in the above-mentioned slots 35, and held in engagement with inner surfaces of the slots 35 through bushes 38, which will be described hereinafter.

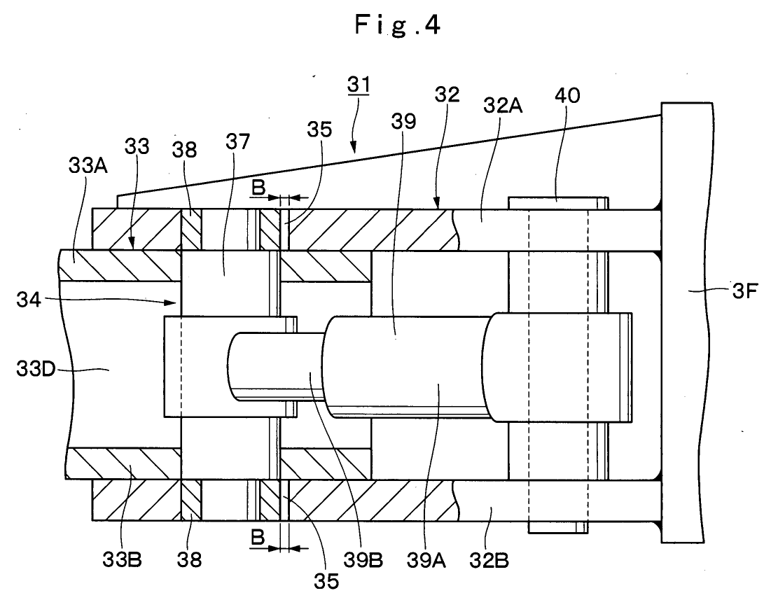

Denoted at 38 are four tubular bushes which are rotatably fitted on axial end portions of the pins 36 and 37. These bushes 38 are retained in position on the opposite axial end portions of the pins 36 and 37 by the use of stopper rings (not shown) or the like. Outer peripheral surfaces of the bushes 38 are held in abutting engagement with inner surfaces of the slots 35. In this instance, the bushes 38 have an outside diameter which is smaller than the width of the slots 35, and a small gap space B is left between the outer periphery of each bush 38 and the inner surface of the slot 35 as shown in FIGS. 4 and 7 to permit rotations of the bushes 38 relative to the pins 36 and 37.

Indicated at 39 is a hydraulic cylinder which is provided between the bracket 32 on the side of the vehicular body and the bracket 33 on the side of the stabilizer. This hydraulic cylinder 39 is composed of a tube 39A, a piston (not shown) which is slidably fitted in the tube 39A, and a rod 39B which is fixed to the piston at its base end and projected out of the tube 39A at the opposite fore end. In this instance, one end of the hydraulic cylinder 39, that is to say, the bottom side of the tube 39A is rotatably connected to a support pin 40 which is provided between the upper and lower plates 32A and 32B of the bracket 32 on the side of the vehicle body. On the other hand, the other end of the hydraulic cylinder 39, that is to say, the projected outer end of the rod member 39B is rotatably connected to the pin 37 which is provided between the upper and lower plates 33A and 33B of the bracket 33 on the side of the stabilizer as described above.

Accordingly, if the rod 39B of the hydraulic cylinder 39 is expanded and/or contracted after setting the footing plates 23 of the stabilizer 18 on the ground, the bracket 32 on the side of the vehicular body is swayed to the right and/or to the left relative to the bracket 33 on the side of the stabilizer. This oscillatory movement of the bracket 32 on the side of the vehicular body is transmitted to the frame 3 of the vehicle body, and, as a result, front portion of the vehicular body 2 is oscillated arcuately about pivot point A or a center point between the left and right rear wheels 6 and 7 along with the load lifting mechanism 12.

In this instance, as the vehicular body 2 is oscillated to the right and/or to the left by the hydraulic cylinder 39, the slots 35 on the side of the bracket 32 on the side of the vehicular body are engaged with the pins 36 and 37 on the bracket 33 on the side of the stabilizer to guide the direction of oscillation of the vehicular body 2 along the arcuate shape of the slots 35.

Further, at this time outer peripheral surfaces of the bushes 38 which are fitted on the opposite end portions of the pins 36 and 37 abutted against inner surfaces of the slots 35 and turned around the pins 36 and 37 in the fashion of rollers. This contributes to reduce friction between the slots 35 and the bushes 38 and to let the vehicular body 2 oscillate smoothly to the right and left along the slots 35.

According to the present embodiment, the lift truck 1 with the above arrangements is operated in the manner as follows.

Firstly, for handling freight goods by the use of the load lifting mechanism 12, the vehicular body 2 is stopped at a working site, and, as shown in FIG. 1, the hydraulic cylinder 24 of the stabilizer 18 is expanded to set the footing plates 23 on the ground for stabilization of the vehicular body 2. At this time, as soon as the stabilizer 18 is set on the ground, the left and right front wheels 4 and 5 are slightly floated off the ground surface while the left and right rear wheels 6 and 7 alone are allowed to rest on the ground as shown in FIG. 3.

In the next place, the control levers (not shown) of the load lifting mechanism 12 are manipulated by an operator within the cab 10 to operate the boom lifting cylinder 15, boom extending cylinder 16 and fork cylinder 17. Then, for example, after loading freight onto the fork 14 at the lowered position of the load lifting mechanism 12, which is indicated by solid line in FIG. 1, the boom lifting cylinder 15 is operated to lift up the boom 13 to the upper lifted position which is indicated by two-dot chain line, for lifting the freight on the fork 14 to a predetermined height.

In this instance, in case the freight is lifted by the load lifting mechanism 12 in a direction which is diverted in a rightward or leftward direction relative to a specified unloading position, it becomes necessary to adjust the position or direction of the lifted freight in a rightward and/or leftward direction. In such a case, pressure oil is supplied to the hydraulic cylinder 39 of the vehicular body oscillating mechanism 31 to expand and contract the rod 39B of the hydraulic cylinder 39 to a suitable degree.

As described above, the rod 39B of the hydraulic cylinder 39 is connected to the bracket 33 on the side of the stabilizer through the pin 37, while the bracket 33 on the side of the stabilizer is fixedly set on the ground.

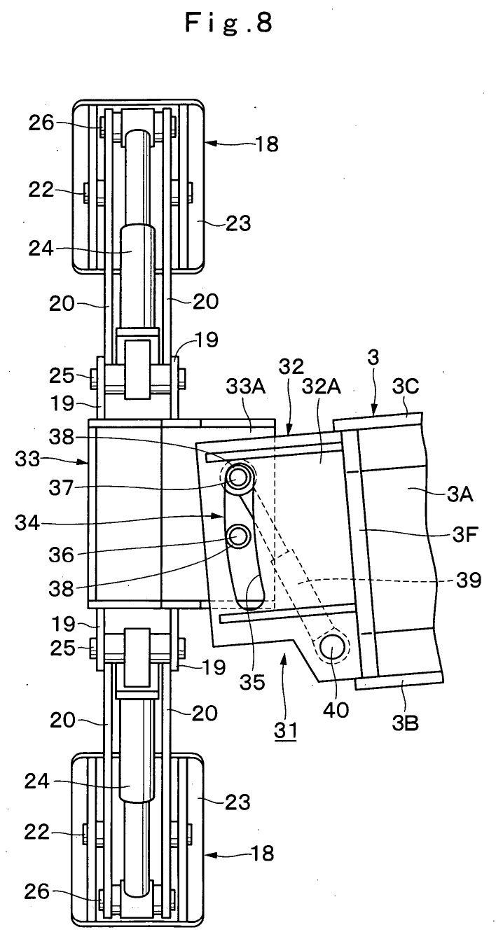

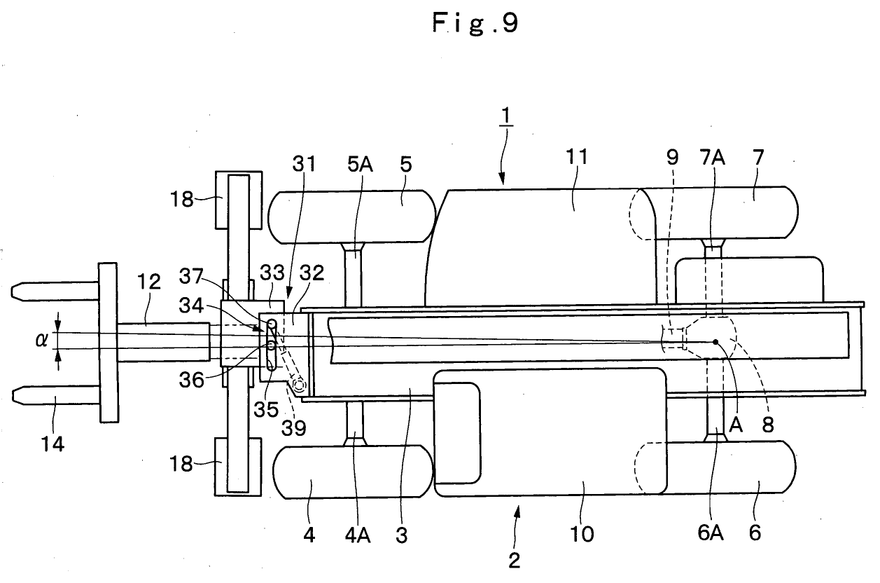

Therefore, as shown in FIGS. 8 and 9, for example, when the rod 39B of the hydraulic cylinder 39 is expanded, the bracket 32 on the side of the vehicular body is swayed arcuately to the leftward direction relative to the bracket 33 on the side of the stabilizer under the guidance of the slots 35 and pins 36 and 37 of the connecting member 34. As a result, while the bracket 33 on the side of the stabilizer remains in a fixed state, the sway of the bracket 32 on the side of the vehicular body is transmitted to the frame 3 of the vehicular body 2.

At this time, the vehicular body 2 stands on the ground by way of the left and right rear wheels 6 and 7 alone, and these left and right rear wheels 6 and 7 are rendered inversely rotatable relative to each other by the differential device 8 between the left and right rear wheel axles 6A, 7A. Therefore, when the bracket 32 and the vehicular body 2 are swung in a leftward direction by the hydraulic cylinder 39, the left rear wheel 6 is slightly rotated in the reverse direction while the right rear wheel 7 is slightly rotated in the forward direction.

As a consequence, as shown in FIG. 9, the front side of the vehicular body 2 is swayed together with the load lifting mechanism 12 within an angular range a in a leftward direction and arcuately along the slots 35, drawing an arcuate locus of movement about a pivot point A which is located at the center of the differential device 8 between the left and right rear wheels 6 and 7. Thus, when the hydraulic cylinder 39 is expanded, the load which has been lifted by the load lifting mechanism 12 can be moved in a leftward direction.

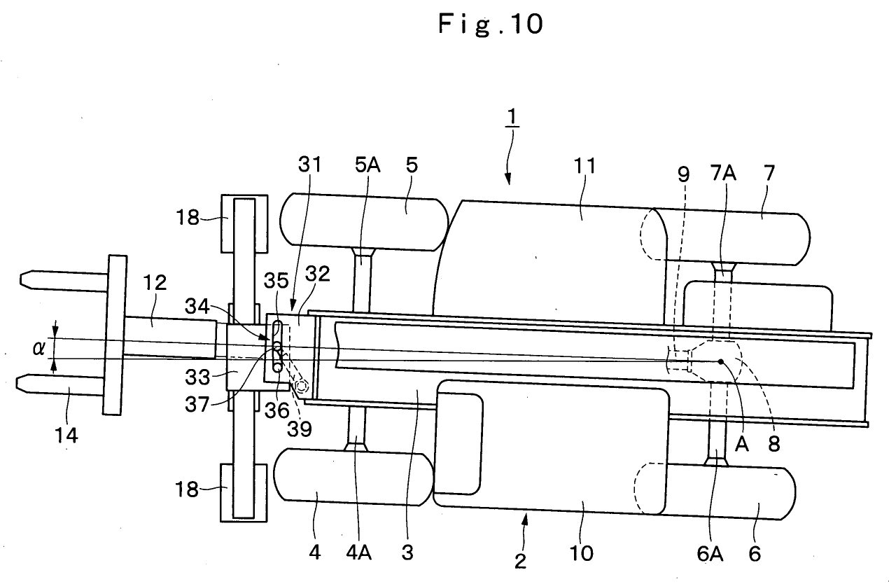

On the other hand, when the rod 39B of the hydraulic cylinder 39 is contracted, for example, the bracket 32 on the side of the vehicular body is arcuately swayed in a rightward direction to the bracket 33 on the side of the stabilizer as shown in FIG. 10, under the guidance of the slots 35 and the pins 36 and 37 of the connecting member 34. This oscillatory movement of the bracket 32 is then transmitted to the vehicular body 2. Whereupon, the left rear wheel 6 is slightly rotated in the forward direction while the right rear wheel 7 is slightly rotated in the reverse direction.

As a result, the front side of the vehicular body 2 is swayed together with the load lifting mechanism 12 within an angular range a arcuately along the slots 35, drawing an arcuate locus of movement about a pivot point A which is located at the center of the differential device 8 between the left and right rear wheel 6 and 7. Thus, upon contraction of the hydraulic cylinder 39, the load which has been lifted by the load lifting mechanism 12 is moved in a rightward direction.

As described above, according to the present embodiment, even after the stabilizer 18 has been set on the ground for stabilization of the vehicular body 2, it is possible to sway the vehicular body 2 in a rightward and/or leftward direction together with the load lifting mechanism 12 by operation of the vehicular body oscillating mechanism 31 while lifting up a load by the load lifting mechanism 12.

Accordingly, even in a case where the position or direction of lifted freight goods on the load lifting mechanism 12 is deviated from a specified unloading spot in a lateral direction, the position or direction of the load lifting mechanism 12 can be adjusted in a lateral direction for unloading the freight goods exactly on a specified unloading spot.

Further, according to the present embodiment, the bushes 38 are rotatably fitted on opposite axial end portions of the pins 36 and 37 which are fixedly planted on the bracket 33 on the side of the stabilizer. Therefore, when the vehicular body 2 is swayed by the hydraulic cylinder 39, the respective bushes 38 are abutted against inner surfaces of the guide slots 35 and rotated around the pins 36 and 37 in the fashion of rollers.

As a result, the friction between the slots 35 and the bushes 38 is lessened to a significant degree to ensure smooth oscillatory movement of the vehicular body 2 along the arcuate shape of the slots 35. In addition, the just-described arrangements contribute to enhance the durability of the pins 36 and 37 on the bracket 33 on the side of the stabilizer as well as the durability of the slots 35 on the bracket 32 on the side of the vehicle body, guaranteeing stable operations of the vehicular body oscillating mechanism 31 over a long period of time.

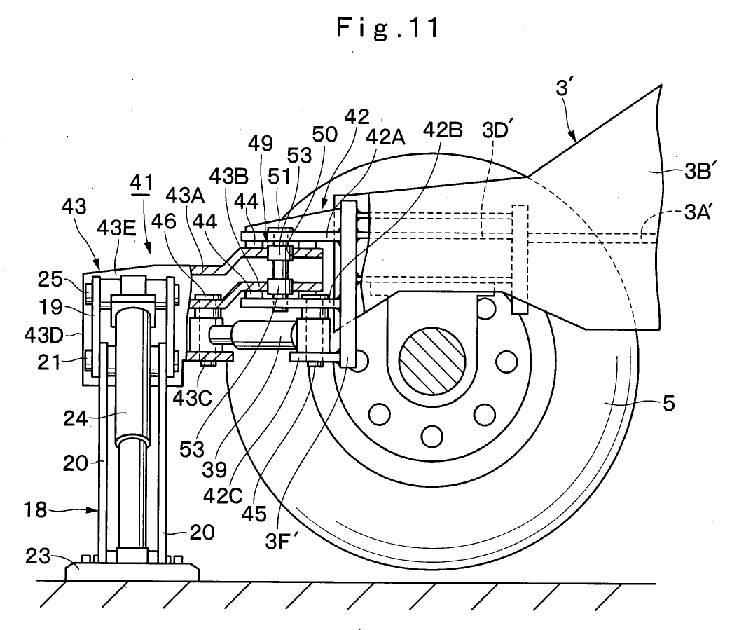

Referring now to FIGS. 11 through 15, there is shown a second embodiment of the present invention. This embodiment has features in that vertical gap spacings are provided between the bracket on the side of the vehicular body and the bracket on the side of the stabilizer, and horizontal gap spacings are provided between the bushes and the guide slots. In the following description of the second embodiment, those component parts which are identical with the counterparts in the foregoing first embodiment are simply designated by the same reference numerals or characters to avoid repetitions of the same explanations.

In the figures, indicated at 3′ is a frame which is employed in the present embodiment in place of the frame 3 in the first embodiment. Similarly to the counterpart in the first embodiment, this frame 3′ is constituted by a bottom plate 3A′, a left side plate 3B′, a right side plate 3C′, a front wheel support portion 3D′ and a rear wheel support portion (not shown). However, attached to the front side of the frame 3′ of the second embodiment is a flange plate 3F′ which is larger in vertical length as compared with the flange plate 3F in the first embodiment.

Indicated at 41 is a vehicular body oscillating mechanism which is adopted by the present embodiment in place of the vehicular body oscillating mechanism 31 of the first embodiment. Similarly to the vehicular body oscillating mechanism 31, this vehicular body oscillating mechanism 41 is actuatable to sway the front side of the vehicular body 2 to the right and left after the right and left footing plates 23 of the stabilizer 18 have been flipped down to set foot on the ground. Similarly, the vehicular body oscillating mechanism 41 is constituted by a bracket 42 on the side of the vehicle body, a bracket 43 on the side of the stabilizer, a connecting member 49 and a hydraulic cylinder 39.

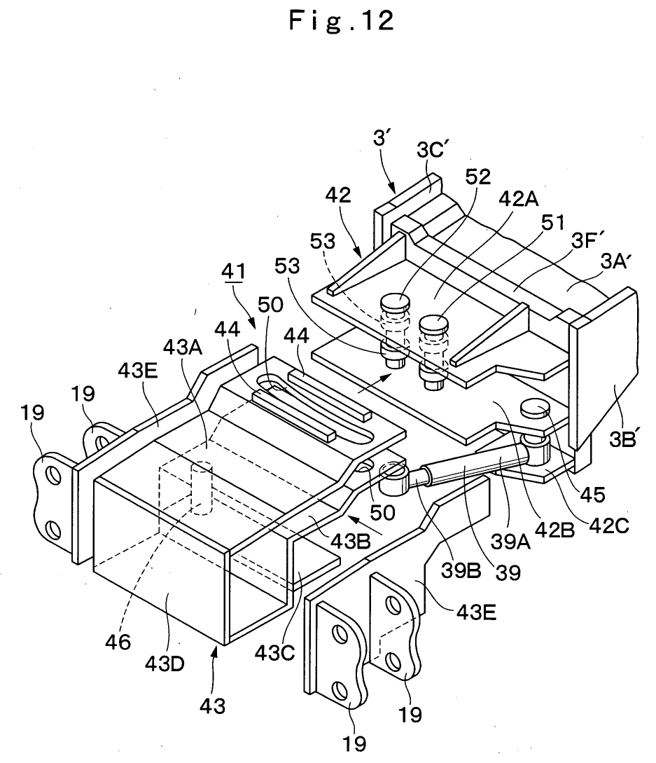

Indicated at 42 is a bracket which is provided at the front end of the vehicular body 2. As shown in FIGS. 11 and 12, the bracket 42 on the side of the vehicular body is constituted by an upper plate 42A, a lower plate 42B and a cylinder mounting plate 42C which are securely fixed to the flange plate 3F′ of the frame 3′ by welding or by the use of bolts or other clamping means. These upper and lower plates 42A and 42B and the cylinder mounting plate 42C of the bracket 42 are vertically faced and spaced substantially in parallel relation with each other.

Designated at 43 is a bracket on the side of the stabilizer which provides stabilizer 18. As seen in FIGS. 11 and 12, this bracket 43 on the side of the stabilizer is formed in a box structure which is enclosed by a upper plate 43A, a lower plate 43B, a cylinder mounting plate 43C, a front plate 43D and left and right side plates 43E. The support plates 19 for the stabilizer 18 are securely fixed to the left and right side plates 43E. The upper and lower plates 43A and 43B of the bracket 43 on the side of the stabilizer are placed between the upper and lower plates 42A and 42B of the bracket 42 on the side of the vehicular body.

A couple of transversely extending slide plates 44 are securely fixed on the top side of the upper plate 43A on the front and rear sides of a guide slot 50, which will be described hereinafter. Similarly, a couple of transversely extending slide plates 44 are securely fixed on the lower side of the lower plate 43B on the opposite sides of a guide slot 50. Each one of these slide plates 44 constitutes part of the bracket 43 on the side of the stabilizer.

On the other hand, a tube 39A of a hydraulic cylinder 39 is rotatably connected on the cylinder mounting plate 42C of the bracket 42 on the side of the vehicular body by the use of a support pin 45, while a rod 39B of the hydraulic cylinder 39 is rotatably connected to the cylinder mounting plate 43C of the bracket 43 on the side of the stabilizer by the use of a support pin 46.

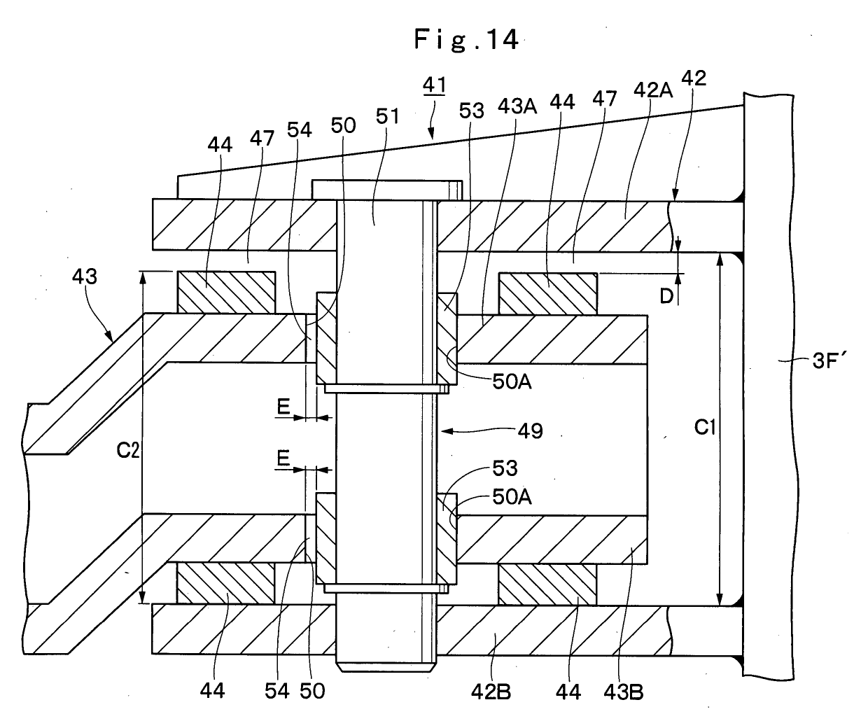

In this instance, assuming that the bracket 42 on the side of the vehicular body has a vertical spacing of a dimension C1 between the upper and lower plates 42A and 42B and the bracket 43 on the side of the stabilizer 18 has a vertical spacing of a dimension C2 between the slide plate 44 fixed on the top side of the upper plate 43A and the slide plate 44 fixed on the lower side of the lower plate 43B of the bracket 43 on the side of the stabilizer as shown in FIG. 14, arrangements are made to have the dimension C1 and C2 in dimensional relations of C1−C2=D.

Namely, the dimension C1 (the height of the vertical spacing between the upper and lower plates 42A and 42B of the bracket 42 on the side of the vehicle body) is larger by D than the dimension C2 (the height of the bracket 43 on the side of the stabilizer, including the slide plates 44 on the upper and lower plates 43A and 43B).

Accordingly, the dimension D is corresponding to a vertical gap space 47 which is parallely formed between the bracket 42 on the side of the vehicular body and the bracket 43 on the side of the stabilizer.

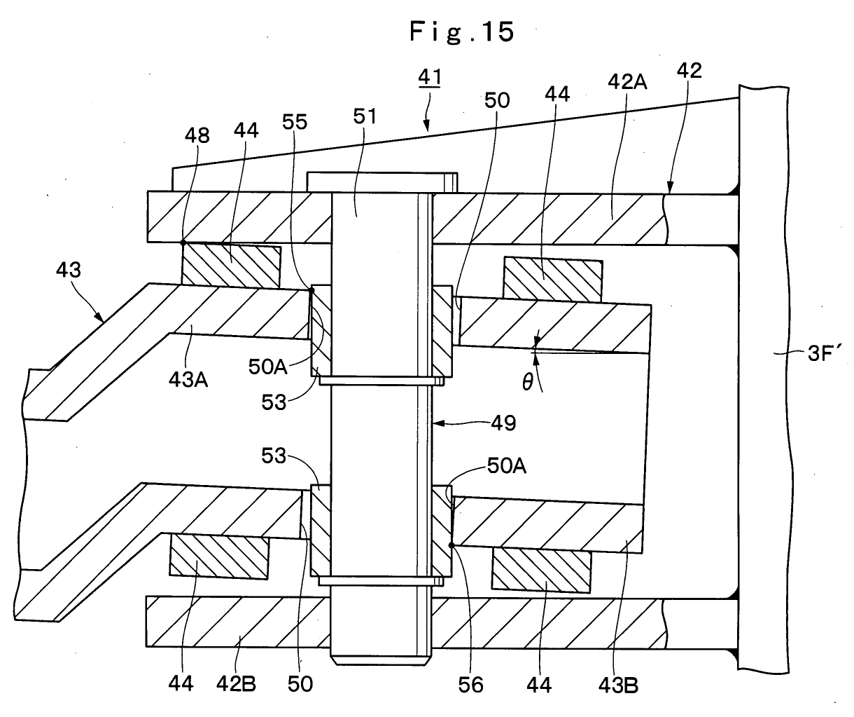

In this instance, the gap space 47 is formed between the bracket 42 on the side of the vehicular body and the bracket 43 on the side of the stabilizer. Therefore, as shown in FIG. 15, when the stabilizer 18 is flipped down to set foot on the ground, the bracket 43 on the side of the stabilizer is caused to incline relative to the bracket 42 on the side of the vehicular body through an angle of inclination θ within the gap space 47 by a load imposed from the side of the vehicular body 2. As a result, a slide plate 44 on the top side of the upper plate 43A of the bracket 43 on the side of the stabilizer is abutted against the upper plate 42A of the bracket 42 on the side of the vehicular body at its upper front edge as indicated by the abutting portion 48 to sustain the load from the vehicular body 2 by and at the abutting portion 48.

Indicated at 49 is a connecting member which is provided between the bracket 42 on the side of the vehicular body and the bracket 43 on the side of the stabilizer. This connecting member 49 serves to connect the bracket 42 on the side of the vehicular body and the bracket 43 on the side of the stabilizer pivotally with each other. For this purpose, the connecting member 49 is constituted by guide slots 50, pins 51 and 52 and bushes 53, which will be described hereinafter.

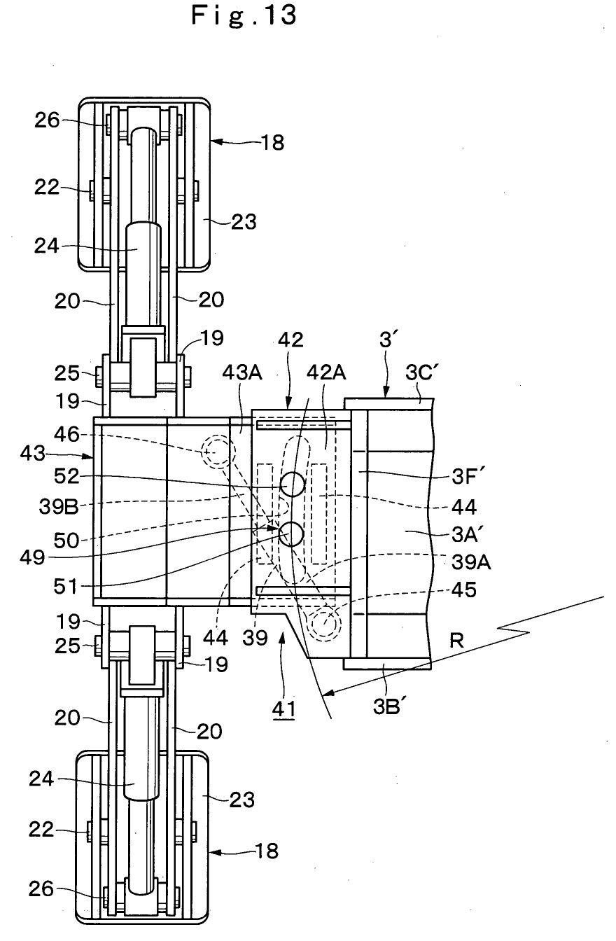

Denoted at 50 are guide slots which are formed in the upper and lower plates 43A and 43B of the bracket 43 on the side of the stabilizer. Similarly to the slots 35 in the first embodiment, these slots 50 are formed in the shape of an arc of radius R having a center located at a pivot point A between the left and right rear wheels 6 and 7 (see FIG. 13).

Indicated at 51 and 52 are left and right pins which are provided on the bracket 42 on the side of the vehicle body, in spaced positions in the longitudinal direction of the guide slots 50. These pins 51 and 52 are provided fixedly on the bracket 42 on the side of the stabilizer and are extended vertically between the upper and lower plates 42A and 42B of the bracket 42. Axially intermediate portions of these pins 51 and 52 are engaged with the slots 50 through a bush 53 which will be described below.

Indicated at 53 are four bushes which are rotatably fitted on the pins 51 and 52. These bushes 53 are fitted on pin portions corresponding in height to the guide slots 50 which are provided on the bracket 43 on the side of the stabilizer. Each one of the bushes 53 is set in position on the pin 51 or 52 by the use of a stopper ring to prevent dislocation, and abutted against inner surfaces 50A of a slot 50 on the outer peripheral side. In this instance, the bushes 53 have an outside diameter which is smaller than the width of the guide slots 50, and, as shown in FIG. 14, a horizontal gap space 54 of a relatively small width E is left between the outer periphery of each bush 53 and inner surface 50A of the guide slot 50.

Since the gap space 54 is left between the outer periphery of the bush 53 and inner surface of the slot 50, the bushes 53 are abutted against the inner surfaces 50A of the guide slots 50 in the upper and lower plates 43A and 43B of the bracket 43 on the side of the stabilizer at upper front edges 55 and lower rear edges 56 of the slots 50, respectively, as shown in FIG. 15 when the bracket 43 on the side of the stabilizer is inclined relative to the bracket 42 on the side of the vehicular body through an angle of inclination θ.

As a consequence, when the bracket 43 on the side of the stabilizer is inclined relative to the bracket 42 by a load imposed from the side of the vehicle body, the load from the vehicular body 2 can be securely sustained by the abutting portions 48 between the brackets 43 and 42 on the side of the stabilizer and the vehicular body and by the upper and lower abutting portions 55 and 56 between the bushes 53 and the guide slots 50.

The lift truck with the above-described vehicular body oscillating mechanism 41 according to the second embodiment is operated in the manner as follows.

Firstly, if the rod 39B of the hydraulic cylinder 39 is expanded and/or contracted during a load handling operation with the stabilizer 18 set on the ground, the bracket 42 on the side of the vehicular body is swayed to the right and/or to the left relative to the bracket 43 on the side of the stabilizer under guidance of the slots 50 and pins 51 and 52 which constitute the connecting member 49.

The oscillatory movement of the bracket 42 on the side of the vehicular body is transmitted to the frame 3 of the vehicular body 2. Whereupon, the front side of the vehicular body 2 is swayed together with the load lifting mechanism 12 arcuately to the right and left about a pivot point A which is located at a center point between the left and right rear wheels 6 and 7. Therefore, even if the position of freight which has been lifted by the load lifting mechanism 12 is deviated from a specified unloading spot in a lateral direction, the load lifting mechanism 12 can be moved in a lateral direction during a load handling operation to dump the lifted freight correctly on a specified unloading spot by the load lifting mechanism 12.

Besides, according to the second embodiment, a vertical gap space 47 is provided between the bracket 42 on the side of the vehicular body and the bracket 43 on the side of the stabilizer, and at the same time a horizontal gap space 54 is provided between the bushes 53 on the pins 51 and 52 and inner surfaces 50A of the guide slots 50.

Therefore, when the stabilizer 18 is set on the ground, the bracket 43 on the side of the stabilizer is inclined relative to the bracket 42 on the side of the vehicular body through an angle of inclination θ within the ranges of the gap spaces 47 and 54 by a load imposed from the side of the vehicular body 2 (shown FIG. 15). At this time, the bracket 43 on the side of the stabilizer is abutted against the bracket 42 on the side of the vehicular body at the abutting portion 48, while the guide slots 50 and the bushes 53 are abutted against each other at the abutting portions 55 and 56. Accordingly, a load which is imposed from the side of the vehicular body 2 can be securely sustained at the abutting portions 48, 55 and 56, permitting to sway the vehicular body 2 in rightward and leftward directions in a stabilized state by the use of the vehicular body oscillating mechanism 41.

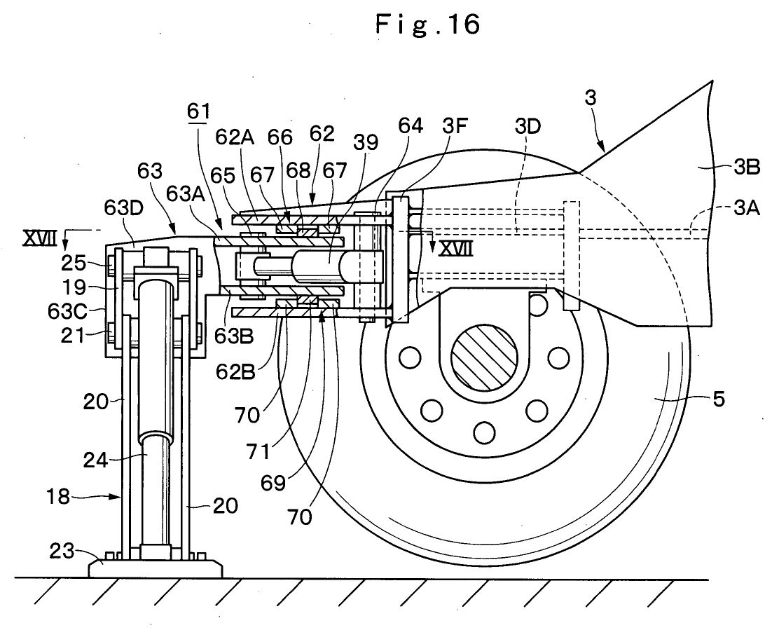

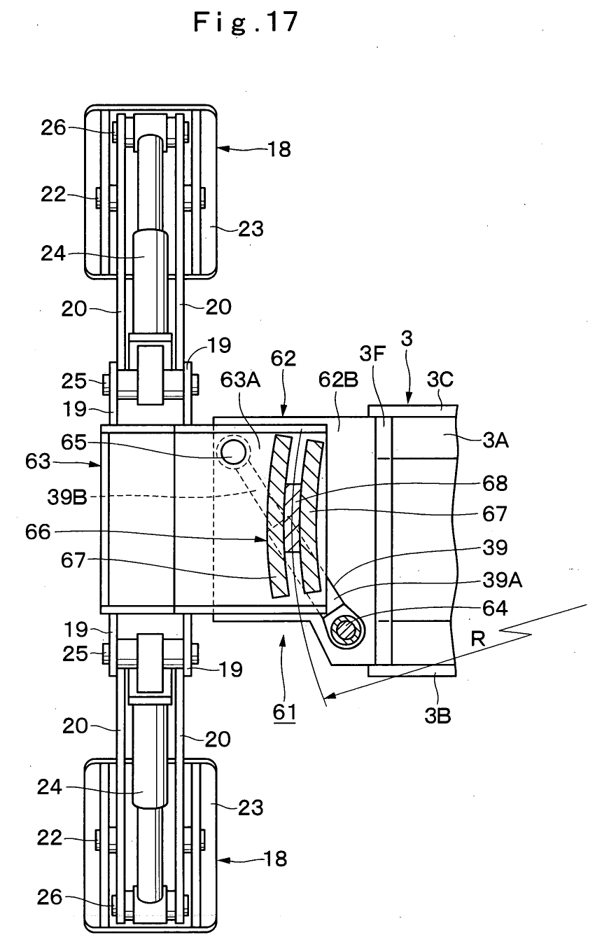

Now, referring to FIGS. 16 and 17, there is shown a third embodiment of the present invention. This embodiment has features in that the connecting member of the vehicular body oscillating mechanism is constituted by an arcuate guide member which is provided on the bracket on the side of the vehicle body, and a slide member which is provided on the bracket on the side of the stabilizer. In the following description of the third embodiment, those component parts which are identical with the counterparts in the above-described first embodiment are simply designated by the same reference numerals or characters to avoid repetitions of the same explanations.

In the drawings, indicated at 61 is a vehicular body oscillating mechanism which is adopted in the present embodiment in place of the vehicular body oscillating mechanism 31 in the first embodiment. This vehicular body oscillating mechanism 61 is constituted by a bracket 62 on the side of the vehicle body, a bracket 63 on the side of the stabilizer, an upper connecting member 66, a lower connecting member 69 and a hydraulic cylinder 39, which will be described hereinafter.

Designated at 62 is a bracket on the side of the vehicle body, which is provided at the fore end of the vehicular body 2. This bracket 62 is constituted by upper and lower plates 62A and 62B which are securely fixed to the flange plate 3F of the frame 3 by welding or by the use of bolts or other clamping means. The upper and lower plates 62A and 62B are extended substantially in the horizontal direction and are spaced from each other in the vertical direction.

Indicated at 63 is a bracket on the side of the stabilizer which provides the stabilizer 18. This bracket 63 on the side of the stabilizer is formed in a box structure which is enclosed by an upper plate 63A, a lower plate 63B, a front plate 63C and left and right side plate 63D. Further, support plates 19 for the stabilizer 18 are securely attached to the left and right side plates 63D.

The upper and lower plates 63A and 63B of the bracket 63 on the side of the stabilizer are placed between the upper and lower plates 62A and 62B of the bracket 62 on the side of the vehicle body. Further, a gap space is provided between the top side of the upper plate 63A and the lower side of the upper plate 62A for an upper connecting member 66 which will be described hereinafter. A gap space is also provided between the lower side of the lower plate 63B and the top side of the lower plate 62B for a lower connecting member 69 which will be described hereinafter.

Further, through a support pin 64, the tube 39A of the hydraulic cylinder 39 is pivotally connected to the upper and lower plates 62A and 62B of the bracket 62 on the side of the vehicle body, and, through a support pin 65, the rod 39B of the hydraulic cylinder 39 is pivotally connected to the upper and lower plates 63A and 63B of the bracket 63 on the side of the stabilizer.

Indicated at 66 is an upper connecting member which is provided between the upper plate 62A of the bracket 62 on the side of the vehicular body and the upper plate 63A of the bracket 63 on the side of the stabilizer. This upper connecting member 66 is constituted by guide plates 67 and a slide plate 68, which will be described hereinafter.

Denoted at 67 are a couple of guide plates which are provided in fore and rear spaced positions on the upper plate 62A of the bracket 62 on the side of the vehicle body. These fore and rear guide plates 67 are each constituted, for example, by a steel plate which is bent into an arcuate shape and securely fixed to the lower side of the upper plate 62A by the use of bolts (not shown). In this instance, each one of the fore and rear guide plates 67 is formed in the shape of an arc having a center at the pivot point A between the left and right rear wheels 6 and 7. As shown in FIG. 17, an arcuate groove is formed between the two guide plates 67, the arcuate groove being in the shape of an arc of radius R having a center at the pivot point A between the left and right rear wheels 6 and 7.

Indicated at 68 is a single slide plate which is provided on the upper plate 63A of the bracket 63 on the side of the stabilizer. This slide plate 68 is constituted, for example, by a steel plate which is bent into an arcuate shape, and securely fixed on the top side of the upper plate 63A by the use of bolts (not shown). Further, the slide plate 68 is placed in the arcuate groove which is formed between the two guide plates 67, and slidably engaged with the two guide plates 67.

Designated at 69 is a lower connecting member which is provided between the lower plate 62B of the bracket 62 on the side of the vehicular body and the lower plate 63B of the bracket 63 on the side of the stabilizer. This lower connecting member 69 is constituted by guide plates 70 and a slide plate 71, which will be described hereinafter.

Denoted at 70 are a couple of guide plates which are provided in spaced fore and rear positions on the lower plate 62B of the bracket 62,on the side of the vehicle body. These guide plates 70 are formed in the same arcuate shape as the above-described guide plates 67. Formed between the two guide plates 70 is an arcuate groove of radius R having a center at the pivot point A between the left and right rear wheels 6 and 7.

Indicated at 71 is a single slide plate which is provided on the lower plate 63B of the bracket 63 on the side of the stabilizer. This slide plate 71 is formed in the same arcuate shape as the above-described slide plate 68. Further, the slide plate 71 is placed in the arcuate groove which is formed between the two guide plates 70, and slidably engaged with the two guide plates 70.

Therefore, as the vehicular body 2 is swayed laterally in a rightward and/or leftward direction by the hydraulic cylinder 39, the oscillatory movement of the vehicular body 2 is guided arcuately along the guide plates 67 and 70 by the slide plate 68 which is in sliding contact with the guide plates 67 of the upper connecting member 66 and the slide plate 71 which is in sliding contact with the guide plates 70 of the lower connecting member 69.

With the above-described vehicular body oscillating mechanism 61, the lift truck according to the third embodiment of the invention is operated in the manner as follows. Firstly, when the stabilizer 18 is set on the ground for stabilization of the vehicle body, the rod 39B of the hydraulic cylinder 39 is expanded and/or contracted. Whereupon, the bracket 62 on the side of the vehicular body is swayed in a rightward and/or leftward direction relative to the bracket 63 on the side of the stabilizer, under guidance of the guide plates 67 and slide plate 68 of the upper connecting member 66 and the guide plates 70 and slide plate 71 of the lower connecting member 69.

Thus, even in the case of the third embodiment, after the stabilizer 18 is set on the ground for a load handling operation, the vehicular body oscillating mechanism 61 can be actuated to sway the vehicular body 2 in a rightward and/or leftward direction along with the load lifting mechanism 12 when freight goods are lifted by the load lifting mechanism 12 in a laterally deviated position or direction relative to a specified unloading spot, adjusting the direction of the vehicular body laterally in a rightward and/or leftward direction to let the load lifting mechanism 12 lift down the freight goods exactly on a specified unloading spot.

In the above-described second embodiment, by way of example the inner surfaces 50A of the guide slots 50 are formed in parallel relation with outer peripheral surfaces of the bushes 53 as shown in FIG. 14.

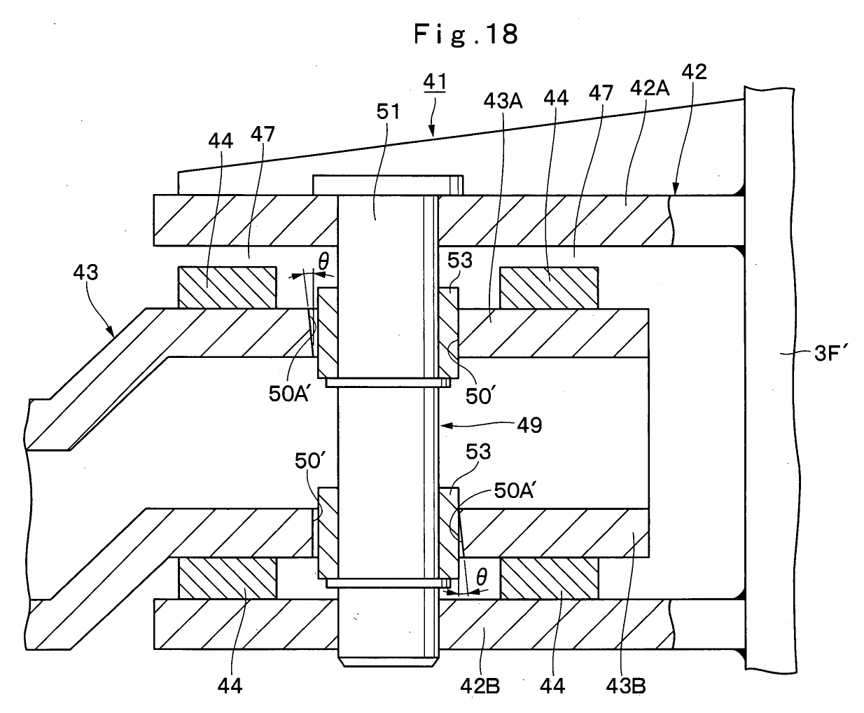

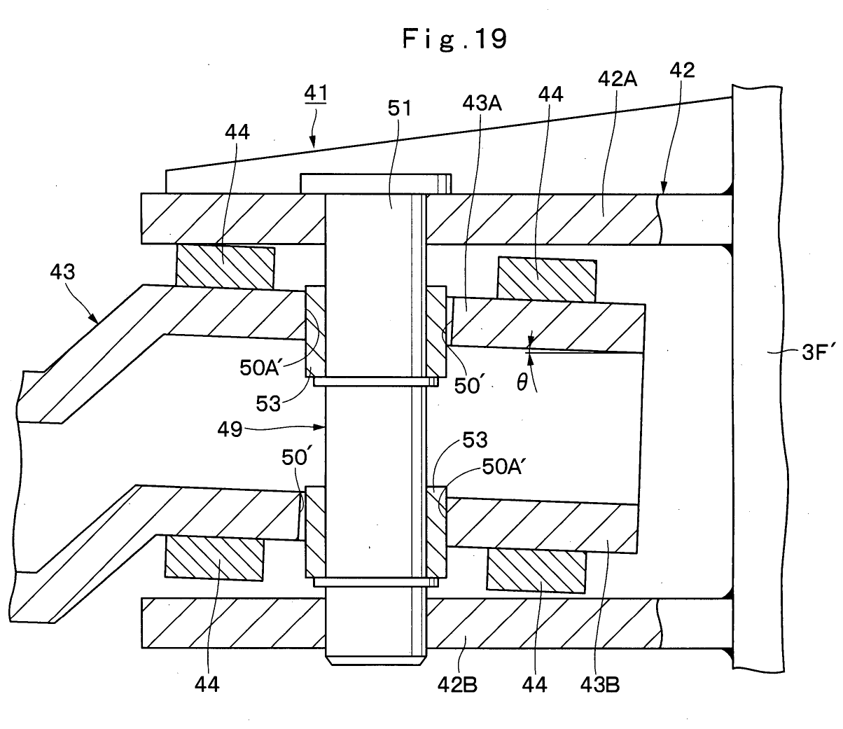

However, it is to be understood that the present invention is not limited to a particular example shown. For example, there may be employed guide slots 50′ which are arranged as in a first modification shown in FIGS. 18 and 19. Namely, in place of the above-described guide slots 50, guide slots 50′ may be provided in the bracket 43 on the side of the stabilizer, the guide slots 50′ having inner surfaces 50A′ which are inclined by an angle θ, which corresponds to an angle of inclination θ of the bracket 43 on the side of the stabilizer relative to the bracket 42 on the side of the vehicle body.

Accordingly, when the bracket 43 on the side of the stabilizer is inclined relative to the bracket 42 through an angle θ by a load imposed thereto from the side of the vehicular body 2 as shown in FIG. 19, the arrangements of the first modification make it possible to increase the contacting surfaces areas outer between the outer surfaces of the bushes 53 and the inclined inner surfaces 50A′ of the guide slots 50′. This means that a load imposed from the side of the vehicular body 2 can be supported more securely by abutting portions of the inclined inner surfaces 50A′ of the guide slots 50′ and the bushes 53.

Further, in the above-described first embodiment, by way of example the stabilizer 18 is shown as being constituted by arms 20, footing plates 23 and hydraulic cylinder 24.

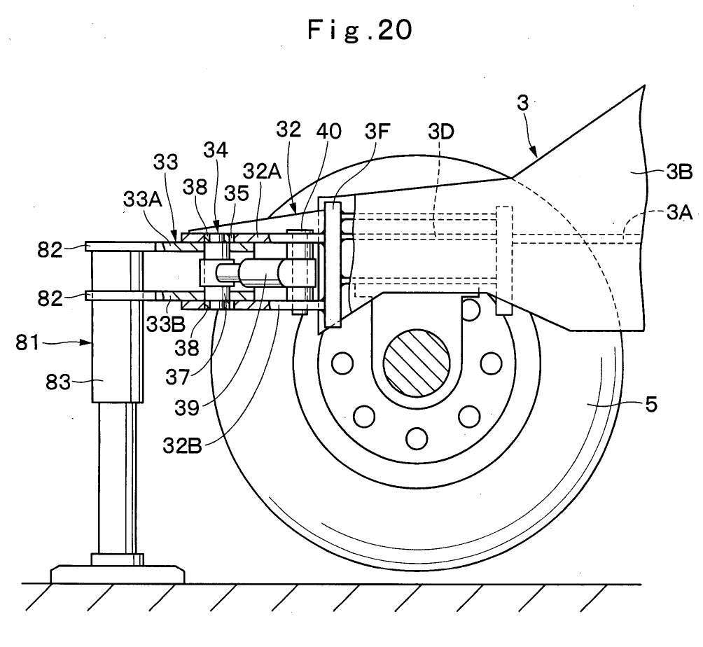

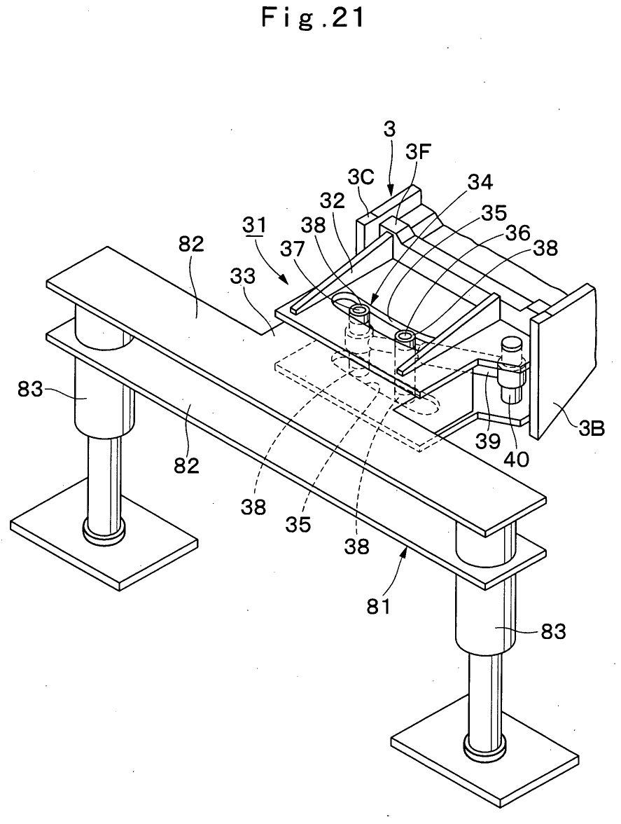

However, it is to be understood that the present invention is not limited to the particular stabilizer construction shown. For example, it is also possible to employ a stabilizer 81 as in a second modification shown in FIGS. 20 and 21. More particularly, it is possible to employ a stabilizer 81 which is constituted by transversely extending upper and lower support frames 82, and left and right hydraulic cylinders 83 which are fixed to and downwardly extended from opposite right and left end portions of the support frames 82.

Furthermore, in the above-described first embodiment, the tube 39A at one end of the hydraulic cylinder 39 is connected to the support pin 40 on the bracket 32 on the side of the vehicle body, and the rod 39B at the other end of the hydraulic cylinder 39 is connected to the pin 37 of the connecting member 34 (FIG. 7).

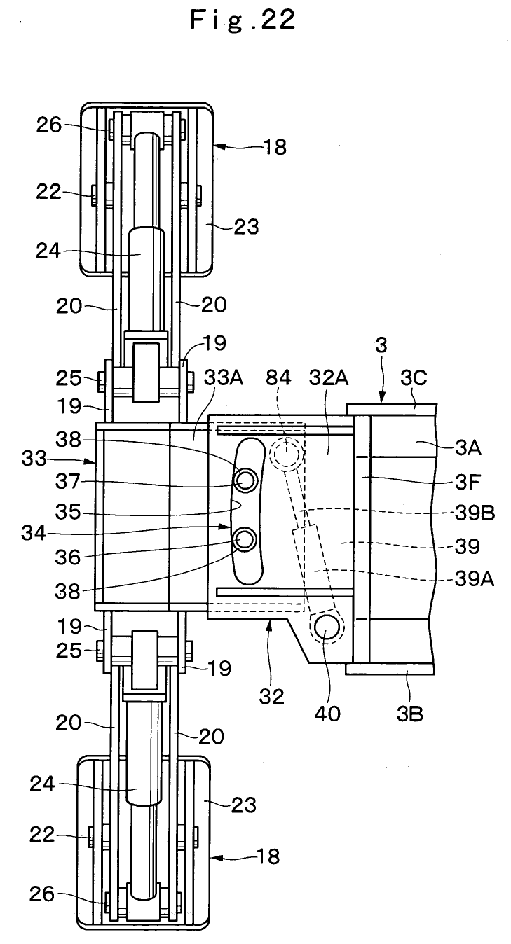

However, the present invention is not limited to the particular arrangements shown. For example, arrangements may be made as in a third modification shown in FIG. 22 if desired. More particularly, in this case, aside from the pins 36 and 37 of the connecting member 34, a support pin 84 is fixedly provided on the bracket 33 on the side of the stabilizer, and the rod 39B of the hydraulic cylinder 39 is connected to the support pin 84.

Further, in each one of the foregoing embodiments, by way of example the differential device 8 is located at the pivot point A between the left and right rear wheels 6 and 7. However, the present invention is not limited to the particular arrangements shown. For example, if desired, the differential device 8 may be located in a position which is shifted or deviated from the pivot point A between the left and right rear wheels 6 and 7.

Furthermore, in the foregoing third embodiment, the two guide plates 67 of the upper connecting member 66 are provided on the bracket 62 on the side of the vehicle body, while the slide plate 68 is provided on the bracket 63 on the side of the stabilizer. In addition, the two guide plates 70 of the lower connecting member 69 are provided on the bracket 62 on the side of the vehicle body, while the slide plate 71 is provided on the bracket 63 on the side of the stabilizer.

However, the present invention is not limited to the particular arrangements shown. For instance, it is possible to provide the two guide plates 67 on the bracket 63 on the side of the stabilizer, while providing the slide plate 68 on the bracket 62 on the side of the vehicle body. Similarly, it is possible to provide the two guide plates 70 on the bracket 63 on the side of the stabilizer, while providing the slide plate 71 on the bracket 62 on the side of the vehicle body.

Moreover, in the foregoing third embodiment, the upper connecting member 66 is constituted by two guide plates, i.e., the fore and rear guide plates 67, and a single slide plate 68 which is interposed between the two guide plates 67. Similarly, the lower connecting member 69 is constituted by two guide plates, i.e., the fore and rear guide plates 70, and a single slide plate 71 which is interposed between the two guide plates 70. However, in this regard, it is to be understood that the present invention is not limited to the particular arrangements shown. For example, the upper connecting member 66 may be constituted by a single guide plate 67 and a couple of slide plates 68 which are arranged to hold the guide plate 67 from the front and rear sides of the latter. Similarly, the lower connecting member 69 may be constituted by a single guide plate 70 and a couple of slide plates 71 which are arranged to hold the guide plate 70 from the front and rear sides of the latter.

Furthermore, in each one the foregoing embodiments, by way of example the present invention is applied to a lift truck which is provided with a fork 14 on the front side of a load lifting mechanism 12. However, it is to be understood that the present invention is broadly applicable to other automotive working machines, including a lift type working vehicle with an operator's deck on the front side of a load lifting mechanism.

1. An automotive working machine, having: an automotive vehicular body (2) including a longitudinally extending frame (3, 3′), right and left front wheels (4, 5) provided in a front portion of said longitudinal frame, and right and left rear wheels (6, 7) provided in a rear portion of said longitudinal frame through a differential device (8); a load lifting mechanism (12) provided on said frame (3, 3′) of said vehicular body (2); a stabilizer (18, 81) provided at a front end of said vehicular body (2) and adapted to set foot on the ground for stabilization of said vehicular body during a load handling operation by the use of said load lifting mechanism (12);
characterized in that said automotive working machine comprises:
a vehicular body oscillating mechanism (31, 41, 61) provided between said frame (3, 3′) of said vehicular body (2) and said stabilizer (18, 81) and actuated to sway said vehicular body (2) arcuately in a rightward and/or leftward direction together with said load lifting mechanism, about a pivot point (A) located between said right and left rear wheels, after said stabilizer is set on the ground for a load handling operation.

2. An automotive working machine as defined in claim 1, wherein said vehicular body oscillating mechanism (31, 41, 61) is comprised by a bracket (32, 42, 62) on the side of the vehicle body attached to said frame (3, 3′) of said vehicular body (2), a bracket (33, 43, 63) on the side of the stabilizer having said stabilizer (18, 81) attached thereto, a connecting member (34, 49, 66, 69) arranged to connect said brackets (32, 42, 62) on the side of the vehicle body and said bracket (33, 43, 63) on the side of the stabilizer pivotally with each other, and a hydraulic cylinder (39) having one end thereof connected to said bracket (32, 42, 62) on the side of the vehicle body and having the other end connected either to said bracket (33, 43, 63) on the side of the stabilizer or to said connecting member (34, 49, 66, 69), said vehicular body oscillating mechanism being actuatable to put said vehicular body (2)in an oscillatory movement by telescopic expanding and contracting actions of said hydraulic cylinder.

3. An automotive working machine as defined in claim 2, wherein said connecting member (34, 49) is constituted by arcuate guide slots (35, 50) provided on one of said bracket (32, 42) on the side of the vehicular body and said bracket (33, 43) on the side of the stabilizer and extended arcuately about said pivot point (A), and a plural number of pins (36, 37, 51, 52) fixedly planted on the other one of said bracket (32, 42) on the side of the vehicular body and said bracket (33, 43) on the side of the stabilizer for engagement with said guide slots (35, 50) in spaced positions in the longitudinal direction of said guide slots (35, 50).

4. An automotive working machine as defined in claim 3, wherein tubular bushes (38, 53) are rotatably fitted on said pins (36, 37, 51, 52) for abutting engagement with inner surfaces of said guide slots (35, 50).

5. An automotive working machine as defined in claim 2, wherein said connecting member (49) is constituted by arcuate guide slots (50) provided on one of said bracket (42) on the side of the vehicular body and said bracket (43) on the side of the stabilizer and extended arcuately about said pivot point (A), a plural number of pins (51, 52) fixedly planted on the other one of said bracket (42) on the side of the vehicular body and said bracket (43) on the side of the stabilizer for engagement with said guide slots (50) in spaced positions in the longitudinal direction of said guide slots (50) and tubular bushes (53) rotatably fitted outer on said pins (51, 52);
said bracket (42) on the side of the vehicular body and said bracket (43) on the side of the stabilizer is vertically spaced apart by a gap space (47); and
said bushes (53) and said guide slots (50) are horizontally spaced apart by a gap space (54);
said bracket (42) on the side of vehicular body and said bracket (43) on the side of the stabilizer being brought into abutting engagement with each other and at the same time inner surfaces (50A) of said guide slots (50) and said bushes (53) being brought into abutting engagement with each other when said bracket (43) on the side of the stabilizer and said bracket (42) on the side of the vehicular body are inclined relative to each other within ranges of said gap spaces (47, 54).

6. An automotive working machine as defined in claim 5, wherein inner surfaces of said guide slots (50′) are formed as inclined surfaces (50A′) at the same angle as angle of inclination (θ) occurring to said bracket (43) on the side of stabilizer relative to said bracket (42) on the side of the vehicle body.

7. An automotive working vehicle as defined in claim 2, wherein said connecting member (66, 69) is constituted by arcuate guide members (67, 70) provided on one of said bracket (62) on the side of the vehicular body and said bracket (63) on the side of the stabilizer and extended arcuately about said pivot point (A), and slide members (68, 71) provided on the other one of said bracket (62) on the side of the vehicular body and said bracket (63) on the side of the stabilizer and held in sliding engagement with said guide members (67, 70).
